(19) United States
(12) Patent Application Publication
(10) Pub. No.: US 2012/0276318 A1
(43) Pub. Date: Nov. 1, 2012

(54) PROTECTIVE FILM WITH A LINER LAYER

(76) Inventor: Gregory C. Franke, Magnolia, TX (US)

(21) Appl. No.: 13/097,489

(22) Filed: Apr. 29, 2011

(51) Int. Cl. B32B 33/00

(52) U.S. Cl. 428/41.8

(57) ABSTRACT

Implementations disclosed herein relate to a protective film with a protective film layer and a liner layer. The protective film may comprise a protective film layer, an adhesive layer, and a liner layer. In one example, the liner layer includes a tab extending from a first edge of the liner layer to beyond a second edge of the liner layer. In one example, the liner layer includes a first portion and a second portion.

### BACKGROUND

A protective film may sometimes be applied to an electronic device. For example, a protective film with an adhesive backing may be applied to an electronic display. The protective film may protect the display from scratches and other damage.

### BRIEF DESCRIPTION OF THE DRAWINGS

The drawings describe example implementations. The following detailed description references the drawings, wherein:

FIG. 1 is a diagram illustrating one example of a protective film with a liner with a tab.

FIGS. 2A and 2B are diagrams illustrating examples of applying a protective film with a liner with a tab.

FIG. 3 is a diagram illustrating one example of a protective film with a first and second liner portion.

FIG. 4A and 4B are diagrams illustrating examples of applying a protective film with a first and second liner portion.

FIG. 5 is a diagram illustrating one example of a protective film with a first liner portion with a tab and a second liner portion.

FIG. 6 is a diagram illustrating one example of a protective film for an electronic device with a first liner portion and a second liner portion with a tab.

### DETAILED DESCRIPTION

A protective film may be applied to an electronic device. For example, the protective film may include an adhesive backing for adhering to an electronic device, such as to a display screen. For larger displays, it may be more difficult to properly apply protective films because, for example, air bubbles and other obstructions getting stuck between the display and the protective film, or part of the protective film attaching such that the remaining protective film is not properly lined up over the electronic device.

A release liner for a protective film for an electronic device may be a removable layer attaching to an adhesive on the protective film. In one implementation, the liner includes a tab that allows for a more easy gradual removal of a release liner. The tab may extend across the liner to extend beyond another side of the liner. For example, the tab may extend from one edge of the release liner to beyond an opposite edge of the release liner such that the part of the tab extending beyond the release liner may be pulled without placing a hand between the release liner and the electronic device when applying the protective film. Keeping the protective film closer to the electronic device as it is applied may also prevent bubbles and other objects from being between the adhesive and the electronic device. The extended tab may allow the protective film to remain placed properly lined up on the electronic device while the release liner is removed. The removal and secondary installation of the protective film may introduce contaminants to the adhesive layer after previous installations. A tab for allowing alignment of the protective film prior to removal of additional portions of the adhesive layer may prevent misalignment and multiple installations.

In one implementation, a release liner for a protective film for an electronic device attaches to the adhesive and includes two portions. For example, a smaller portion of the liner backing may be removed so that the protective film may be lined up on the device. After the smaller portion is removed and the smaller portion of the adhesive adheres to the electronic device, the larger portion of the release liner backing may be removed, in some cases in a gradual manner, such that the remaining protective film may adhere to the electronic device. Allowing a small part of a protective film to attach without leaving the adhesive on the second portion exposed may make it easier to attach a small portion of the adhesive such that the rest is already lined up. It may also allow the protective film to be properly lined up without exposing the adhesive for a longer amount of time, which may reduce the likelihood of dust and other particles adhering to the adhesive.

In one implementation, a two portion release liner with a tab on the larger portion is used together to allow a protective film to be more easily placed on an electronic device. For example, a smaller portion of the release liner backing may be removed to stick a portion of the protective film on the electronic device, and then an extended tab may be used to remove the remaining liner from the adhesive. Used together, the protective film may be placed with better alignment and fewer air bubbles or other disruptions.

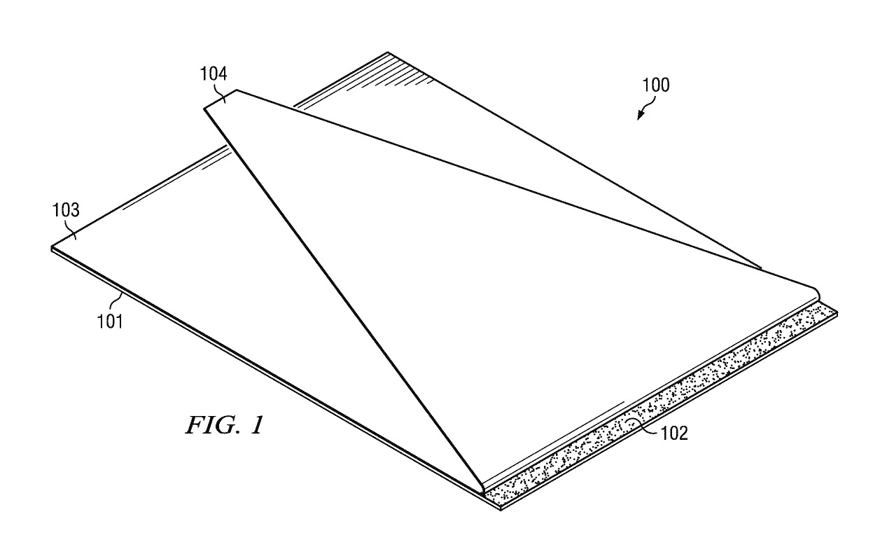

FIG. 1 is a diagram illustrating one example of a protective film for an electronic device with a liner with a tab. The protective film 100 includes a protective film layer 101, an adhesive layer 102, a liner layer 103, and a tab 104. The protective film 100 may be used to protect an electronic device, such as to protect a display screen of an electronic device. The protective film 100 may be applied by removing the liner layer 103 from the adhesive layer 102 such that the adhesive layer 102 binds the protective film layer 101 to the surface of an electronic device. The tab 104 may be used to remove the liner layer 103 from the adhesive layer 102. The extended tab may allow for placing the protective film 100 in a desired position over an electronic device before exposing the adhesive layer 102.

The protective film layer 101 may be made from any material suitable for protecting an electronic device. For example, the protective film layer 101 may be a plastic film. The adhesive layer 102 may be made of any suitable adhesive, such as glue. The adhesive layer 102 may bind to the protective film layer 101. The adhesive layer 102 may bind to the liner layer 103 in a manner that allows the liner layer 103 to be removed from the adhesive layer. When the liner layer 103 is removed, the adhesive layer 102 may bind the protective film layer 101 to the surface of an electronic device. The liner layer 103 may be made of any suitable material for binding to the adhesive layer 102 in a temporary manner. The tab 104 may be an extra piece of material attached the liner layer 103 or an extension of the liner layer fashioned to create a pull tab.

The tab 104 may extend from one edge of the liner layer to beyond another edge of the liner layer such that the tab may be pulled to remove the liner layer 103 without placing a hand between the protective film layer 101 and a surface for binding to the adhesive layer 102. The protective film 100 shows the tab 104 extending lengthwise across the liner layer 103, but the tab may extend across the liner layer in any suitable direction, such as across the width or along a diagonal.

In some implementations, the end of the tab 104 for pulling may be smaller than the dimension of the liner layer 103 such that the tab may be more easily pulled than pulling the entire side of the liner layer 103. For example, the tab 104 is shown such that the edge for pulling to remove the liner layer 103 is smaller than the edge of the liner layer 103. For example, the tab 104 may be less than four centimeters wide on the end section of the tab 104 to be pulled to remove the liner layer 103. In some implementations, the tab 104 may be in the center or middle portion of an edge of the liner layer 103. This positioning may, for example, allow for more uniform removal of the liner layer 103. In some implementations, the tab 104 may be tapered towards the center of the liner layer 103 as it extends beyond the liner layer. For example, the tab 104 is shown to be the full length of the liner layer 103 on one edge and tapering towards a smaller pull tab on the portion of the tab to be pulled to remove the liner layer 103.

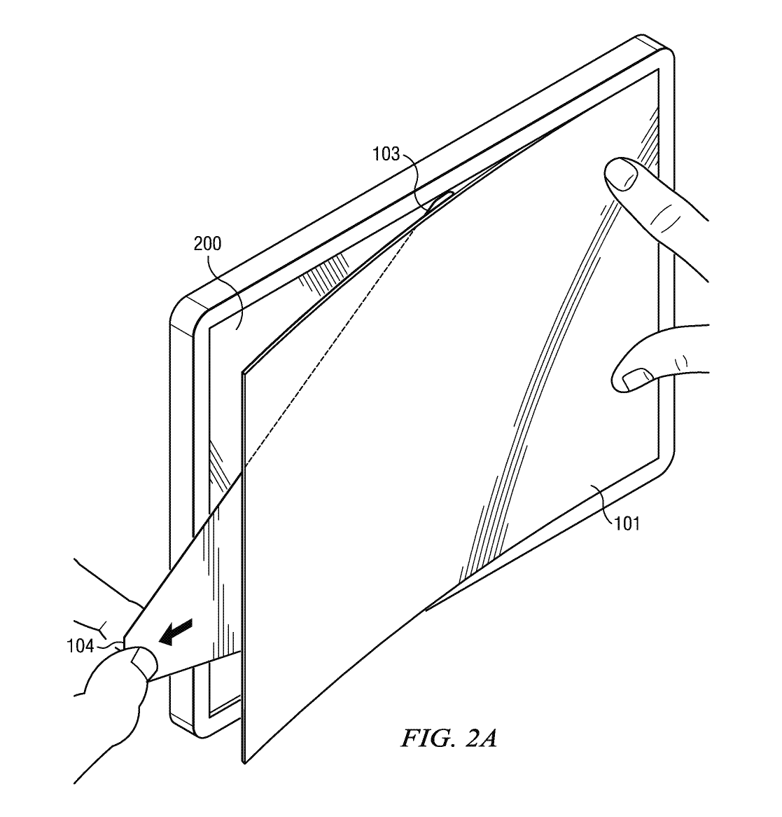

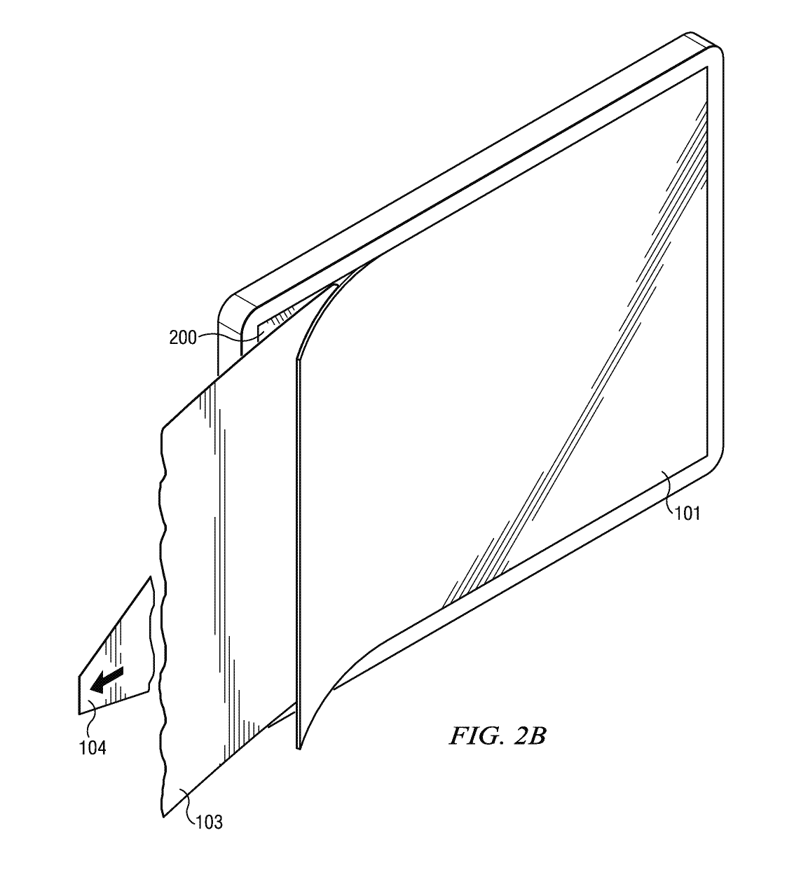

FIGS. 2A and 2B are diagrams illustrating examples of applying a protective film with a liner with a tab. FIG. 2A shows the tab 104 pulled such that a portion of the liner layer 103 is removed revealing the adhesive layer 102 to bind to the surface of an electronic device 200. FIG. 2B shows the tab 104 pulled farther such that a larger portion of the adhesive layer 102 is revealed. The protective film layer 101 may be pressed onto the electronic device 200 as the liner layer 103 is removed.

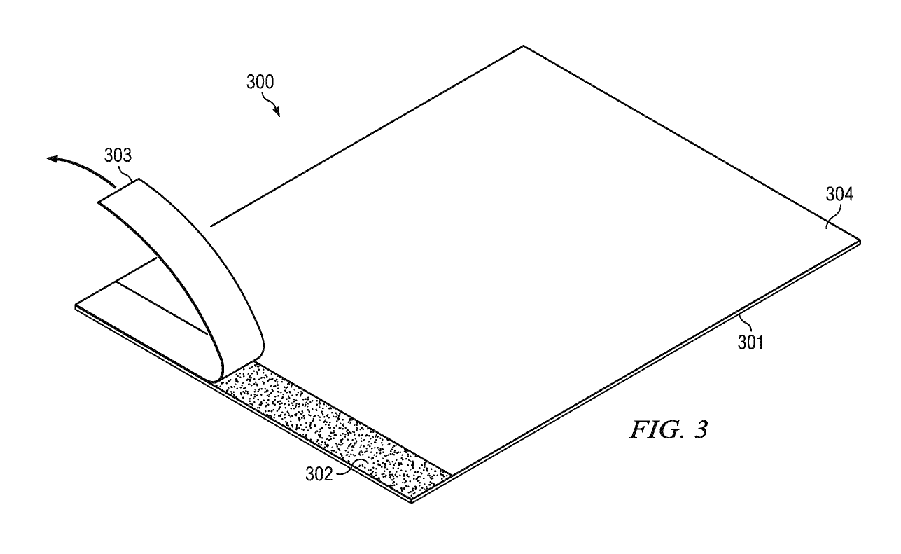

FIG. 3 is a diagram illustrating one example of a protective film with a first and second liner portion. The protective film 300 includes a protective film layer 301, an adhesive layer 302, a first liner layer 303, and a second liner layer 304. In some implementations, the first liner layer 303 and the second liner layer 304 may be peeled away from the adhesive layer 302 so that the protective film layer 301 may adhere to an electronic device, such as to a display screen. The first liner layer 303 may attach to a smaller portion of the adhesive layer 302 than the second liner layer 304. The first liner layer 303 may be removed so that the protective film layer 301 may be lined up with the electronic device and then adhere to the portion of adhesive revealed by the removal of the first liner layer 303. After the initial part of the protective film layer 301 adheres to the electronic device, the second liner layer 304 may be removed such that the second liner layer 304 reveals adhesive from the adhesive layer 302 for attaching the remaining portion of the protective film layer 301 to the electronic device. The protective film 300 shows the first liner layer 303 peeled back to reveal a portion of the adhesive layer 302.

The protective film layer 301 may be composed of any suitable material for protecting an electronic device, such as a type of plastic film. The adhesive layer 302 may be attached to the protective film layer 301 on one side and to the first liner layer 303 and the second liner layer 304 on the opposite side. The adhesive layer 302 may be composed of a material for attaching the protective film layer 301 to the surface of an electronic device. For example, the adhesive layer 305 may adhere to the surface of an electronic device when the second liner layer 304 or the first liner layer 303 is removed.

The first liner layer 303 and the second liner layer 304 may each attach to a portion of the adhesive layer 302. In some cases, the first liner layer 303 and the second liner layer 304 may overlap such that one of the liner layers is attached to the adhesive layer 302 at the overlapping portion and the other liner layer is on top. The first liner layer 303 and the second liner layer 304 may be positioned adjacent to one another as shown in FIG. 3 such that the first liner layer 303 may be removed to attach a beginning portion of the protective film 301 and the second liner layer 304 may be removed to attach the remaining portion. The two portions may attach to the protective film 301 in any suitable divisions. For example, FIG. 3 shows a lengthwise division of the protective film 301, but a division along the width or along another dimension is also possible. In some implementations, there may be additional liner layer portions such that the protective film 301 may be applied in more than two stages.

In some implementations, the first liner layer 303 may be smaller than the second liner layer 304. For example, the first liner layer 303 may allow a small portion of the protective film layer 301 to be applied without exposing a large amount of the adhesive layer 102. The first liner layer 303 may be, for example, less than four centimeters in one dimension. In some cases, the first liner layer 303 may cover less than ten percent of the adhesive layer 302.

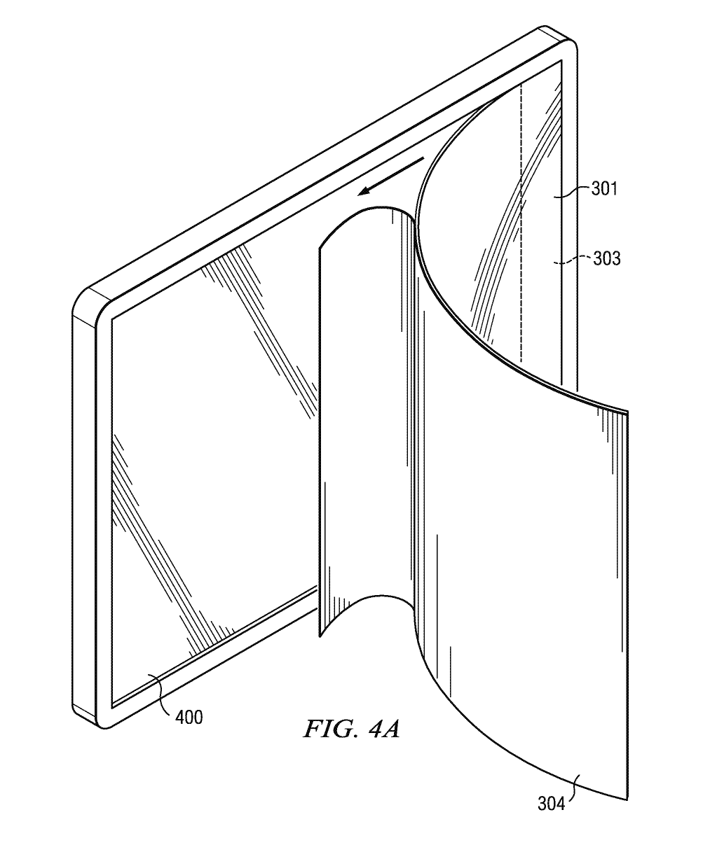

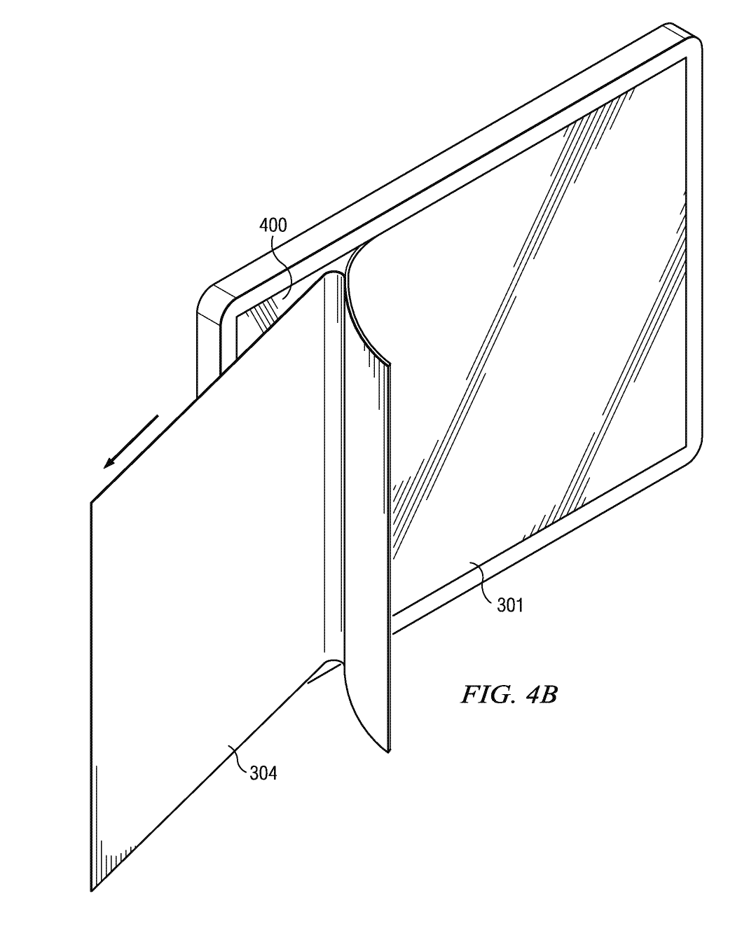

FIG. 4A and 4B are diagrams illustrating examples of applying a protective film with a first and second liner portion. FIG. 4A shows the protective film layer 301 lined up on an electronic device 400. For example, the first liner layer 303 may be removed so that the portion of the protective film 301 previously covered by the first liner layer 303 may be attached to the electronic device 200. FIG. 4B shows the second liner layer 304 partially removed from the protective film 301 such that more of the protective film is placed on the electronic device 400. Exposing a small amount of adhesive while lining up the protective film 301 may prevent dust and other particles from attaching the adhesive layer 302 where a larger portion of the adhesive layer 302 is exposed. Also attaching a smaller portion may keep other portions of adhesive from sticking to the electronic device and messing up the alignment.

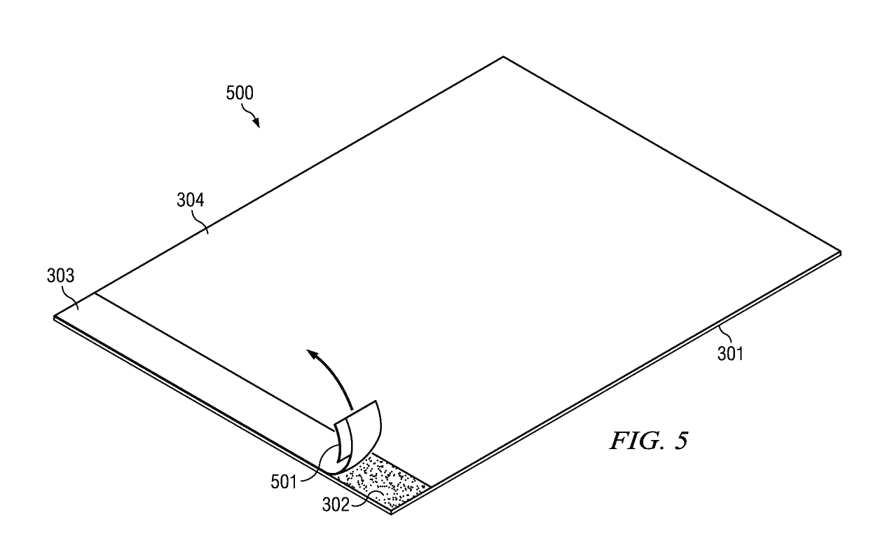

FIG. 5 is a diagram illustrating one example of a protective film for an electronic device with a first liner portion with a tab and a second liner portion. The protective film 500 includes the protective film layer 301, the first liner layer 303, the second liner layer 304, and the adhesive layer 302. The first liner layer 303 includes a tab 501 for removing the first liner layer 303. The tab may be an extension of the first liner layer 303 or a separate piece of material attached to the first liner layer 303. The tab 501 may be a tab extending off one side of the first liner layer 303. In some implementations, the tab 501 extends across the first liner layer 303 to extend beyond another edge of the first liner layer 303 in a similar manner to the tab 104 in FIG. 1.

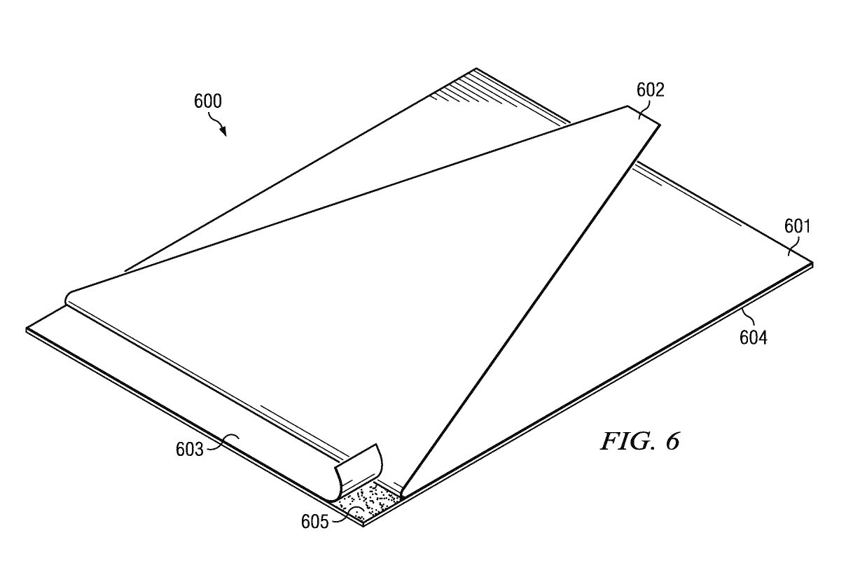

FIG. 6 is a diagram illustrating one example of a protective film for an electronic device with a first liner portion and a second liner portion with a tab. The protective film 600 includes a protective film layer 604, and adhesive layer 605, a first liner layer 603, and a second liner layer 601. The second liner layer 601 includes tab 602 extended across the second liner layer 601 from a first edge of the second liner layer 601 to beyond a second edge of the second liner layer 601.

To apply the protective film layer 604 to the surface of an electronic device, the first liner layer 603 may be removed from the adhesive layer 605. The first liner layer 603 may be removed in some cases using a tab on the first liner layer 603. The removal of the first liner layer 603 may reveal a portion of the adhesive layer 605 beneath the first liner layer 603, and the exposed portion of the adhesive layer 605 may be lined up on the surface of an electronic device and attached to the electronic device. The second liner layer 601 may be removed using the tab 601 to pull the second liner layer 601 from the adhesive layer 605 while pressing the portion of the adhesive layer 605 revealed to attach to the electronic device. Using multiple liner layer portions and an extended tab may allow the protective film layer 604 to be properly lined up on the electronic device before exposing a large amount of the adhesive layer 605. In addition, the exposed portion of the adhesive layer 605 may be closer to the electronic device, causing less dust and other particles from collecting on the exposed portion.

1. An apparatus, comprising:
a protective film layer;
an adhesive layer attached to one side of the protective film layer;
a liner layer attached to the adhesive layer on the side of the adhesive layer not attached to the protective film layer; and
a tab extending from a first edge of the liner layer to beyond a second edge of the liner layer across the side of the liner layer not attached to the s adhesive layer.

2. The apparatus of claim 1, wherein the tab tapers towards the center of the liner layer as the tab extends across the side of the liner layer to beyond the edge.

3. The apparatus of claim 1, wherein the portion of the tab extending beyond the opposite edge of the liner layer is positioned at a middle portion of the edge of the liner layer.

4. The apparatus of claim 1, wherein the portion of the tab extending beyond the second edge of the liner layer includes a width of less than four centimeters.

5. The apparatus of claim 1, wherein the second edge of the liner layer is on an opposite edge of the liner layer as the first edge.

6. The apparatus of claim 1, further comprising a second liner layer attached to the adhesive layer adjacent to the liner layer.

7. An apparatus, comprising:
a protective film layer;
an adhesive layer attached to one side of the protective film layer; and
a first and second liner layer attached to the adhesive layer on a side of the adhesive layer not attached to the protective film layer,
wherein the first liner layer attaches to a first portion of the adhesive layer and the second liner layer attaches to a second portion of the adhesive layer.

8. The apparatus of claim 7, wherein the first liner layer covers less than ten percent of one dimension of the adhesive layer.

9. The apparatus of claim 7, wherein the first liner layer comprises less than four centimeters of one dimension of the adhesive layer.

10. The apparatus of claim 7, wherein the first liner layer includes a tab on the edge of the first liner layer.

11. The apparatus of claim 10, wherein the first liner layer tab extends from a first edge of the first liner layer to beyond a second edge of the first liner layer across the side of the first liner layer not attached to the adhesive layer.

12. The apparatus of claim 7, wherein the second portion comprises the remaining adhesive layer not attached to the first liner layer.

13. The apparatus of claim 7, wherein the second liner layer includes a tab extending from one edge of the second liner layer across the side of the second liner layer not attached to the adhesive layer to beyond a second edge of the second liner layer.

14. An apparatus, comprising:
a protective film layer;
an adhesive layer attaching to one side of the protective film layer; and
a first and second liner layer,
wherein the first liner layer attaches to a first portion of the adhesive layer and the second liner attaches to a second portion of the adhesive layer adjacent to the first portion; and
wherein a tab extends from one edge of the second liner layer across the second liner layer to beyond a second edge of the second liner layer.

15. The apparatus of claim 14, further comprising a tab on the edge of the first liner layer.
